(19) United States
(12) Patent Application Publication
(10) Pub. No.: US 2009/0263064 A1
(43) Pub. Date: Oct. 22, 2009

(54) ANGULAR BALL BEARING ASSEMBLY FOR SUPPORTING A GEAR SHAFT ASSEMBLY

(75) Inventors: Ben BAER, DENFIELD (CA); Valentin DRAGAN, Breslau (CA)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 12/427,891

(22) Filed: Apr. 22, 2009

Related U.S. Application Data
(60) Provisional application No. 61/047,019, filed on Apr. 22, 2008.

(51) Int. Cl. F16C 19/38; F16C 33/58

(52) U.S. Cl. 384/512; 384/513

(57) ABSTRACT

The angular ball bearing assembly for supporting a rotatable shaft with gears has two sets of ball bearing members where the ball bearing member located adjacent the gears has an inner raceway formed integrally with the shaft. By forming the inner raceway directly on the shaft a reduction in friction is achieved compared to conventional tapered roller bearings.

### FIELD OF THE INVENTION

This invention relates to bearings and, more particularly, to angular contact ball bearings used in gear shaft assemblies, especially power transmission applications which employ a pinion shaft or a spline shaft.

### BACKGROUND OF THE INVENTION

FIG. 1 illustrates conventional transmission 100. Transmission 100 is provided with pinion shaft (drive pinion) 102 placed in case 101. Pinion shaft 102 has, on one axial end thereof, a pinion gear 106 that is engaged with ring gear 108 of transmission mechanism 107. Pinion shaft 102 is supported so as to freely rotate about its axis by tapered roller bearings 103 and 104. Companion flange 105 is attached to the other axial end of pinion shaft 102.

In transmission 100, a bearing device, which rotatably supports the pinion shaft 102, is made up of tapered roller bearings 103 and 104 for rotatably supporting pinion shaft 102. Such tapered roller bearings are recognized as generating a great deal of heat and friction.

Angular contact tandem ball bearings have also been used in differential applications in order to reduce the temperature generated by the friction of tapered roller bearings, see for example U.S. Pat. No. 3,826,543.

Also the use of ball bearings with double raceways and inner rings fitted onto the shaft have been suggested for use in differential application, see U.S. Pat. No. 7,350,977. In the '977 patent, a large diameter ball is used in the raceway adjacent the gear while a smaller diameter ball is used in the raceway which is spaced away from the gear, referred to as the anti-pinion side of the double raceway.

### OBJECTS OF THE INVENTION

It is an object of the invention to improve the performance of bearings used in gear shaft assemblies and especially in transmission applications so as to reduce the friction and reduce the fuel consumption. It is also an object of the invention to minimize heat generated by the bearing assembly employed in gear shaft assemblies such as transmission applications. It is another object of the invention to increase the load capacity of the bearing assembly compared to conventional ball bearing designs used in gear shaft assemblies such as transmission applications.

These and other objects of the invention will be more readily understood by reference to the following description.

### SUMMARY OF THE INVENTION

These and other objects are achieved by integrating the shaft into the angular ball bearing assembly. By integrating the shaft, the friction in the angular ball bearing assembly is reduced compared to tapered bearing designs. Furthermore, fuel consumption is also reduced by integrating the shaft into the angular ball bearing assembly of the invention. Furthermore, the load capacity of the angular ball bearing assembly of the invention is higher than in conventional ball bearing designs because of the integration of the shaft into the assembly. Furthermore, increased gear life and reduced gear noise are achieved in the invention. Because of the reduction in heat and friction, less expensive seals and oils can be used in the assembly. Furthermore, the angular ball bearing assembly of the invention requires less lube flow.

Broadly, the invention can be defined as an angular ball bearing assembly which rotatably supports a shaft having a gear on one end of the shaft in an axial direction, the assembly comprising a first angular bearing member on the shaft and axially adjacent the gear and a second angular bearing member on the shaft spaced axially away from the first angular bearing member, the first angular bearing member having a first inner raceway formed directly on the shaft, a first outer raceway formed on an outer ring, the inner and outer raceway forming a pair of cooperative raceways for a first set of balls positioned between the first inner raceway and first outer raceway; the second angular bearing member having a second inner raceway, a second outer raceway formed on the outer ring, the inner and outer raceway forming a pair of cooperative raceways for a second set of balls positioned between the second inner raceway and the second outer raceway.

Preferably, a first ball cage is used for the first set of balls and a second ball cage is used for the second set of balls. The first ball cage is preferably a window ball cage while the second ball cage is preferably a claw ball cage.

The second inner raceway can be formed directly on the shaft or it can be formed on an inner ring which is press fitted onto the shaft.

It is also suitable, that two, first angular bearing members are employed.

The outer ring can be a single outer ring or it can be divided into two outer rings, one providing the first outer raceway and a second outer ring which provides the second outer raceway.

In the case where an inner ring is used for the second inner raceway, the inner ring can be space apart by using a spacer that abuts a shoulder of the shaft.

These and other aspects of the invention may be more readily understood by reference to one or more of the following drawings and the description that follows thereafter.

### BRIEF DESCRIPTION OF THE DRAWINGS

FIG. 1 illustrates a prior art transmission with a pinion shaft and tapered roller bearings;

FIG. 2 illustrates the invention on a pinion shaft;

FIG. 3 illustrates an exploded view of the invention of FIG. 1;

FIG. 4 illustrates the invention on a pinion shaft with the first and the second inner raceway formed integrally on the shaft;

FIG. 5 illustrates the invention of FIG. 4 on a spline shaft;

FIG. 6 illustrates the invention with an inner ring forming the second inner race and a spacer between the shaft and the inner ring; and

FIG. 7 illustrates the invention where the outer ring is split into two, two first angular bearing members are employed, and an inner ring is used for the second inner raceway.

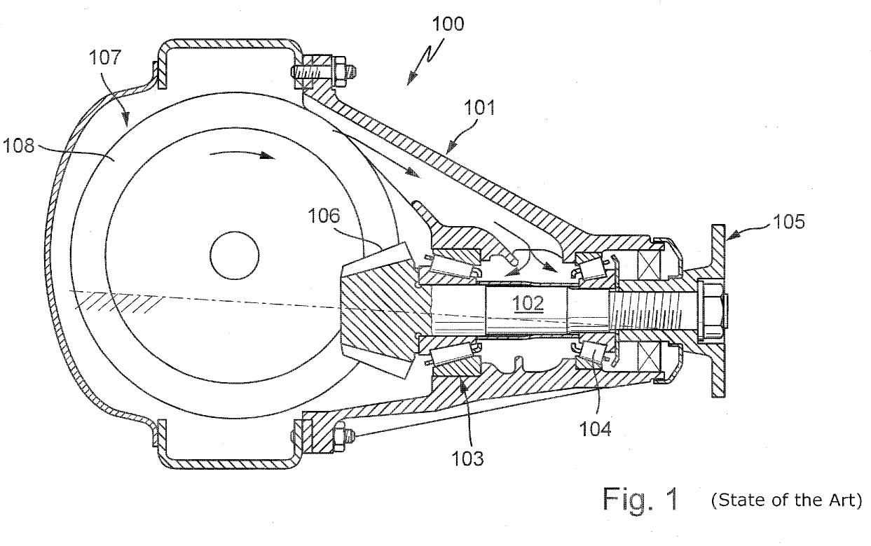

### DETAILED DESCRIPTION OF THE DRAWINGS

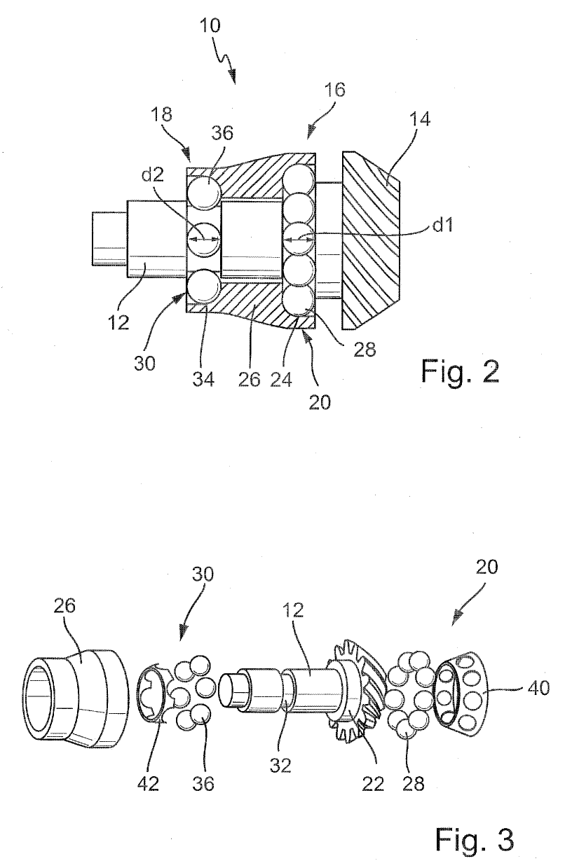

FIG. 2 illustrates angular ball bearing assembly 10 of the invention on pinion shaft 12 having pinion gear 14. First angular bearing member 20 is adjacent in an axial direction pinion gear 14, while second angular bearing member 30 is spaced away from first angular bearing member 20, as illustrated.

First angular bearing member 20 is made up of first inner raceway 22 (see FIG. 3), first outer raceway 24 positioned in outer ring 26 and first set of balls 28. The diameter of each ball in first set 28 has a diameter d₁.

Second angular bearing member 30 is made up of second inner raceway 32 (see FIG. 3), second outer raceway 34 is formed in outer ring 26 and each ball in second set of balls 36 has a diameter d₂ for a diameter.

Turning to FIG. 3, which is an exploded view of the invention illustrated in FIG. 2, it can be seen that first inner raceway 22 and second inner raceway 32 are integrally formed in pinion shaft 12.

As illustrated in FIG. 3, a first cage 40 used with first set of balls 28 and second cage 42 is used with second set of balls 36. As illustrated in FIG. 3, cage 40 is a window-type ball cage and cage 42 is a claw-type ball cage. The combination of ball cage 42 and second set of balls 36 forms a Conrad assembly.

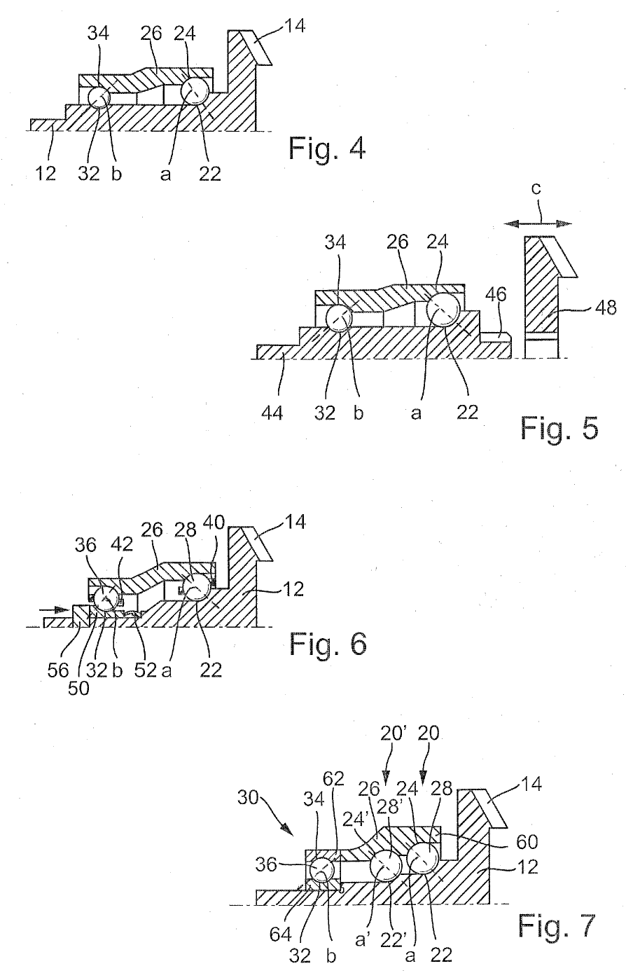

FIG. 4 illustrates the invention of FIG. 3 in cross section showing the relationships between the balls 28, 36 and the angular contact between the inner raceways 22, 32 and the outer raceways 24, 34. As can be seen, the invention of FIGS. 3 and 4 employ a common outer ring 26. Both the first inner raceway 22 and the second inner raceway 32 are formed directly on, i.e. integrally with shaft 12. Preferably, no spacer is employed between the ring or rings that form first outer raceway 24 and second outer raceway 34.

As can be seen in FIG. 4, diameter do of first set of balls 28 is larger than diameter d₂ of second set of balls 36, however, d₁ and d₂ can be the same size or vary according to spacing and application requirements. The contact angle between the balls 28, 36 in the inner raceways 22, 32 and outer raceways 24, 34 for the first bearing member 20 and second bearing member 30 is shown by lines a and b. These are preferably equal and opposite angles.

In order to assemble the invention illustrated in FIGS. 2, 3, and 4, it will be recognized that the pinion set of balls 28, 36 is placed in the respective cage 40, 42 and then the cage 40, 42 is slid into position from the non-pinion end of the shaft 12. As will be appreciated, the first set of balls 28 with cage 40 are slid first onto shaft 12 and then the outer ring 26 is slid onto the first set of balls 28 and then the second set of balls 36 are filled in while the shaft 12 is in a tilted position. Then the shaft 12 is re-aligned. Then the second set of balls 36 are spaced and cage 42 is inserted.

Turning to FIG. 5, the angular ball assembly of FIG. 4 is illustrated on spline shaft 44 with spline teeth 46 and spline gear 48. Arrow c illustrates the movement of spline gear 48.

The assembly of the angular ball bearing illustrated in FIG. 5 is identical to the assembly of FIGS. 2-4.

FIG. 6 illustrates the angular ball bearing assembly in a common outer ring 26. First inner raceway 22 is formed integrally with shaft 12. However, second inner raceway 32 is formed on inner ring 50 and inner ring 50 is spaced by spacer 52 away from shoulder 54 of shaft 12. Nut 56 preloads inner ring 50 for it to flex spacer 52 as illustrated.

FIG. 7 illustrates the invention with two first angular bearing members labeled 20 and 20′. Each bearing member has a first inner raceway labeled 22 and 22′, a first outer raceway labeled 24 and 24′, and two first sets of balls labeled 28 and 28′. Each ball of the two first sets of balls have diameters d₁ and d_{1′}. It will be recognized that d₁ and d_{1′} are equal to each other. In this arrangement, the shaft 12 is used to integrally form the first inner raceway for each of the first angular bearing members.

It can also be seen in FIG. 7 that the outer ring is split into a first outer ring 60 and a second outer ring 62. Also, inner ring 64 is press fitted onto shaft 12.

As illustrated in FIGS. 2-7, first inner raceway 22 is integrally formed, i.e. directly formed on shaft 12 or shaft 44. The inner raceway opens axially outwards away from gear 14 and 46.

The axial spacing between first angular bearing member 20, 20′ and second angular bearing member 30 must be large enough to allow for assembly of the bearing.

As can be seen in FIGS. 3-7, first inner raceway 22, and first outer raceway 24 are preferably shoulderless in opposite axial directions. First inner raceway 22 has no shoulder in an axial direction facing away from the gear and first outer raceway 24 has no shoulder in an axial direction facing the gear.

Also, as can be seen in FIGS. 3-7, outer raceway 34 has preferably no shoulder in an axial direction facing away from the gear. It can also be seen in FIG. 7 that first inner raceway 22′ preferably has no shoulder in the axial side facing away from the gear.

### REFERENCE CHARACTERS

10 Angular ball bearing assembly
12 Shaft, pinion shaft
14 Pinion gear
20,20′ First angular bearing member
22, 22′ First inner raceway
24, 24′ First outer raceway
26 Outer ring
28, 28′ First set of balls
d₁, d_{1′} Diameter of ball in first set 28
30 Second angular bearing member
32 Second inner raceway
34 Second outer raceway
36 Second set of balls
d₂ Diameter of ball in second set 32
40 First cage
42 Second cage
44 Spline shaft
Spline teeth
Spline gear
50 Inner ring
52 Spacer
54 Shoulder
56 Nut
a Line
b Line
c Arrow
60 First outer ring
62 Second outer ring
64 Inner ring
100 Transmission
101 Case
102 Pinion shaft
103 Tapered roller bearing
104 Tapered roller bearing
105 Flange
106 Pinion gear
107 —
108 Ring gear

1. A ball bearing assembly which rotatably supports a shaft having a gear at one end of the shaft in an axial direction, the assembly comprising:
a first angular bearing member on the shaft and axially adjacent the gear and a second angular bearing member on the shaft spaced axially away from the first angular bearing member,
the first angular bearing member having a first inner raceway formed directly on the shaft, a first outer raceway formed on an outer ring, the inner and outer raceway forming a pair of cooperative raceways for a first set of balls positioned between the first inner raceway and first outer raceway;
the second angular bearing member having a second inner raceway, a second outer raceway formed on the outer ring, the inner and outer raceway forming a pair of cooperative raceways for a second set of balls positioned between the second inner raceway and the second outer raceway.

2. The assembly of claim 1 further comprising:
a first ball cage positioned about the first set of balls.

3. The assembly of claim 2, wherein the first ball cage is a window ball cage.

4. The assembly of claim 1 further comprising a second ball cage positioned about the second set of balls.

5. The assembly of claim 4, wherein the second ball cage is a claw ball cage.

6. The assembly of claim 1, wherein the second inner raceway is formed directly on the shaft.

7. The assembly of claim 1, wherein the second inner raceway is formed in an inner ring and the inner ring is press fitted onto the shaft.

8. The assembly of claim 1, having two first angular bearing members.

9. The assembly of claim 1, wherein the outer ring is divided into two outer rings, a first outer ring having the first outer raceway and a second outer ring having the second outer raceway, the first outer ring and the second outer ring axially abutting each other.

10. The assembly of claim 7, wherein a spacer is positioned axially between the inner ring and a shoulder on the shaft.

11. The assembly of claim 1, wherein the shaft is a pinion shaft.

12. The assembly of claim 1, wherein the shaft is a spline shaft having a spline gear at the one end of the shaft.
